(19) United States
(12) Patent Application Publication
(10) Pub. No.: US 2015/0046188 A1
(43) Pub. Date: Feb. 12, 2015

(54) Systems and Methods for Administering Medical Claims from a Motor Vehicle Insurance Policy

(71) Applicant: Lucid Medical Management, LLC, Houston, TX (US)

(72) Inventor: Shawn Carlos De La Garza, Houston, TX (US)

(21) Appl. No.: 14/455,280

(22) Filed: Aug. 8, 2014

Related U.S. Application Data
(60) Provisional application No. 61/864,144, filed on Aug. 9, 2013.

(51) Int. Cl. G06Q 40/08; G06F 19/00

(52) U.S. Cl. CPC G06Q 40/08; G06F 19/328
USPC 705/3

(57) ABSTRACT

Systems and methods are disclose for; receiving information related to a medical claim by an insured party identified in a motor vehicle insurance policy, the information including an identifier of a service provider that provided healthcare services to the insured party; determining whether the policy includes a medical care and payments provision that requires the insured party to utilize one or more of a plurality of healthcare providers in a specified network of healthcare providers for medical claims under the policy; and determining whether the service provider is one of the plurality of healthcare providers when it is determined that the policy includes the medical care and payments provision.

### CROSS REFERENCE TO RELATED APPLICATIONS

This is a non-provisional of U.S. Provisional Patent Application Ser. No. 61/864,144, filed Aug. 9, 2013, to which priority is claimed, and which is incorporated herein by reference in its entirety.

### FIELD OF THE INVENTION

The present invention relates generally to the management of medical care and the administration of medical claims related to a motor vehicle accident (MVA), and more particularly, to a system and method for offering a motor vehicle insurance option (e.g., a rider or endorsement) that decreases motor vehicle insurance costs and results in a timelier resolution of medical claims for both the voluntary and involuntary insurance markets.

### BACKGROUND

Motor vehicle insurance policies often include provisions that cover insured parties (e.g., a policyholder, a policyholder's dependents, or a policyholder's employees if the policyholder is an employer such as a self-insured company or governmental entity) against personal injuries sustained in a motor vehicle accident (MVA). When a party is injured in a MVA, the costs of medical bills may first be recovered under these motor vehicle insurance provisions. Motor vehicle insurance provisions that cover an insured party for personal injuries sustained when no other party is at fault (i.e., the insured party is determined to be at fault or no party is determined to be at fault) may commonly be labeled as personal injury protection (“PIP”) or medical payments protection (“MedPay”). Motor vehicle insurance may also include provisions that cover an insured party against personal injuries sustained in a motor vehicle accident in which another party is determined to be at fault but is unable to pay for the insured party's medical expenses. These provisions are commonly described as uninsured motorist (“UM”) or underinsured motorist (“UIM”) coverage. In some states, certain provisions of these types of coverage may be mandatory, while in others, they may be optional. These types of insurance can be contrasted with other forms of health insurance, which may take effect when an individual requires medical care for injuries and illnesses that are not sustained during or as a result of a MVA.

After a MVA, an injured party (e.g., a driver, passenger, pedestrian, or bicyclist) may be taken to a hospital to have immediate injuries treated. In other cases, such as when the sustained injury does not require immediate hospital attention or does not manifest at the time of the MVA, an injured party may choose to visit a healthcare provider (e.g., a hospital, urgent care facility, or other clinic such as a medical doctor (MD), a doctor of osteopathic medicine (DO), a doctor of chiropractic (DC), an imaging center, a physical therapist, etc.) hours, days, or weeks after the MVA. In either of these cases, the medical provisions of the motor vehicle insurance policy may pay for the medical expenses or reimburse the injured party. Most existing motor vehicle insurance policy medical provisions consist of “at will” and “any willing provider” provisions that allow an insured party to obtain treatment from any healthcare provider they choose.

While the majority of payments made under the medical provisions of motor vehicle insurance policies are for legitimate medical expenses incurred as a result of a MVA, it is not uncommon for such provisions to be abused by unscrupulous medical and legal practitioners. Legal practitioners (attorneys) who engage in this type of barratry take advantage of the legal circumstances surrounding the insurance system, which results in increased insurance costs and delays in settling claims. For example, a situation may arise in which an insured party (e.g., a motorist or pedestrian) that is involved in a MVA has suffered little or no injury. However, a legal or healthcare provider may contact the motorist or pedestrian and convince them to file a medical claim on their behalf that exceeds any legitimate expenses that were incurred as a result of the MVA. Although these types of proposals are often illegal under state and/or federal laws and regulations, they may be difficult to detect. A healthcare provider who is complicit in the deception may evaluate the party's injuries and magnify the scope of the injuries, the duration during which care will be necessary, and the costs for treatment. The attorney may be responsible for enforcing the rights of the insured party against the insurer or insurers to ensure that inflated and perhaps unnecessary payment is made by the insurance company or companies.

The benefits paid by the insurance company may then be shared by the legal practitioner, the healthcare provider, and the insured party. These types of dealings are harmful in several ways. For example, the fraudulent claim creates costs that must be paid by the insurer, either as the benefit that is paid out, investigative costs to confirm the claims, or as defendant legal expenses, where little or no costs would have been due absent the deception. Even in situations in which a legitimate injury has occurred, the healthcare provider often charges fees that are high enough to cover the referral fee to the attorney and possibly provide a kickback to the insured party. Moreover, if an attorney files a lawsuit on behalf of an insured party, the insurance company incurs additional expenses including legal fees to contest the charges and the length of time during which medical claims remain unresolved is increased. These types of lawsuits are detrimental to the function of our legal system as a whole in that they require valuable judicial resources be expended on frivolous claims rather than legitimate controversies.

FIG. 1 illustrates a typical process 100 for administering medical payments under a motor vehicle insurance policy. Process 100 typically begins when an insured party initiates the claim process after the party is involved in a MVA (block 105). The claim process may often be initiated from the scene of the MVA or shortly after the MVA. In a typical scenario, the insured party may contact a claims department with his or her insurer after a MVA in order to provide details about the MVA (e.g., by telephone, web application, email, or using a mobile application provided by the insurer). The insured party will typically be asked standard questions about any property damage or injuries that occurred as a result of the MVA. A claim identifier may be established to serve as a reference for status and requests for the payment of expenses incurred as a result of the MVA. Although a motor vehicle insurance claim may typically involve payments to compensate an insured party or vehicle owner for property damage in addition to medical expenses, this patent application is primarily directed to the administration of claims for medical care and expenses under a motor vehicle insurance policy.

After the claim process has been initiated, the insured party may submit medical expenses to the insurer (or employer) for payment (block 110). The requests may be submitted either directly by the insured party or by a healthcare provider that has provided services to the insured party. As noted above, this portion of the claim process is susceptible to abuse. Because under existing motor vehicle insurance policies medical services may be obtained from any healthcare provider, unscrupulous attorneys and healthcare providers may coordinate with the insured party to defraud the insurer by submitting unnecessary expenses (e.g., inflated and/or unnecessary care, test, or treatment expenses) and expenses that exceed any legitimate costs that the insured party may have incurred as a result of the MVA. The fact that these schemes are immoral and typically illegal is often not a deterrent. The potential loss of medical or legal licenses may deter some, but not all, of those who would engage in such fraudulent schemes. Further, certain healthcare providers may not have licensing requirements as stringent as others, and thus the risk of losing a license may not be a deterrent at all.

If the insured party is determined to be at fault or if no party is determined to be at fault for the MVA (the “Yes” prong of block 115), the submitted medical expenses may be paid under the personal injury protection or medical payments provisions of the insured party's insurance policy (block 125). If another party is determined to be at fault for the MVA (the “No” prong of block 115) but the at fault party is uninsured or is inadequately insured (i.e., underinsured) (the “No” prong of block 120) to cover the insured party's medical expenses, the medical expenses may be paid under the personal injury protection, medical payments, uninsured party, or underinsured party provisions of the insured party's insurance policy as set forth in accordance with the policy (block 130). If the at fault party is adequately insured (the “Yes” prong of block 120), the medical payments may be made under the bodily injury liability portion of the at fault party's insurance policy (block 135). As is understood by those of ordinary skill in the art, the insured party may initially receive payments from his or her insurer even when another party is at fault, and the insurer may recover from the at fault party (or the at fault party's insurer) through a process known as subrogation.

The costs that the insurer incurs as a result of the abusive medical claims and legal filings practices described above are spread among the insurer's policyholders, thus raising the cost of insurance for everyone. It is therefore desirable to provide an insurance offering (such as a rider, endorsement, or option) or for self-insured parties a direct risk reduction that could limit these costs and spread the benefit of these limited costs among those that contractually accept the offering.

### BRIEF DESCRIPTION OF THE DRAWINGS

FIG. 1 is a flowchart that illustrates a typical process according to which a party may recover for medical expenses incurred as a result of a MVA.

FIG. 2 is a flowchart that illustrates a process to provide an insurance offering designed to limit the costs incurred by an insurer as a result of abusive medical claim practices in accordance with one embodiment.

FIG. 3A is a flowchart that illustrates a process for administering medical claims by a Third Party Administrator (TPA) when a claim process is initiated at the time of or after an insured party has obtained medical care, tests, or treatment from a healthcare provider.

FIG. 3B is a flowchart that illustrates a process for administering medical claims by a TPA when a claim process is initiated before an insured party has obtained medical care, tests, or treatment from a healthcare provider.

FIG. 4 is an example timeline of events that illustrates one or more points where information is collected by a TPA for the coordination of medical care and administration of medical claims in accordance with one embodiment.

FIG. 5 is a block diagram of a software module illustrating the aggregation of information and the generation of information associated with the coordination of medical care and administration of medical claims in accordance with one embodiment.

FIG. 6 is a block diagram of a system that may be used to implement processes for the coordination of medical care and administration of medical claims in accordance with one embodiment.

FIG. 7 is a block diagram that conceptually illustrates the benefits obtained through the coordination of medical care and administration of medical claims in accordance with one embodiment.

FIG. 8 is a block diagram illustrating a representative hardware environment for one or more components of the system illustrated in FIG. 6 in accordance with one embodiment.

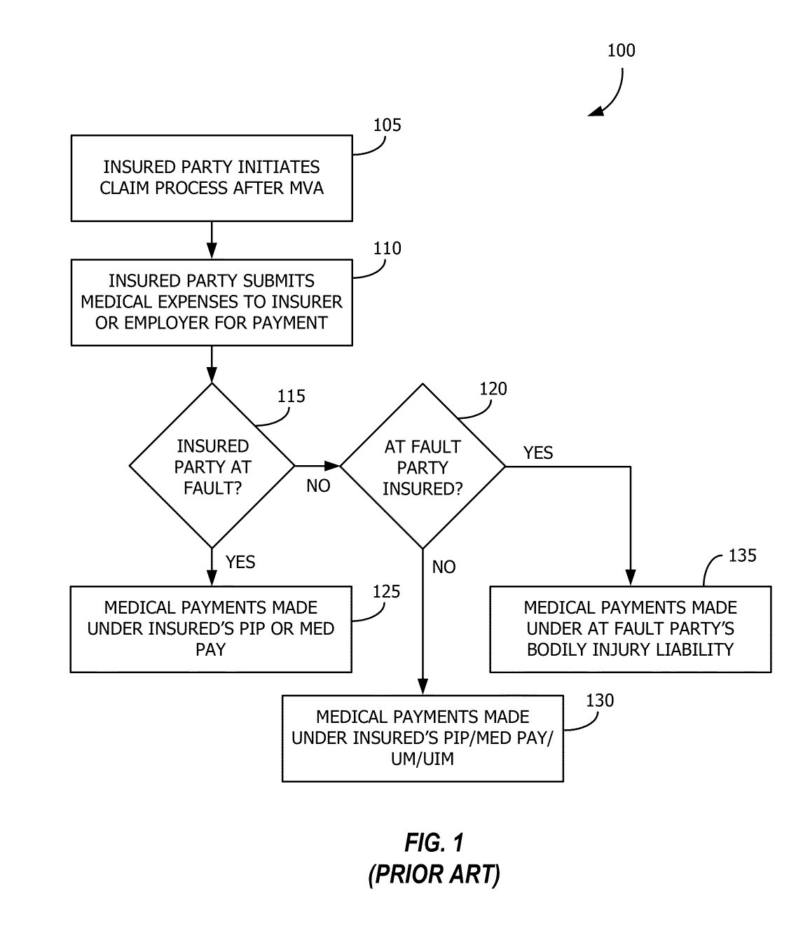

### DETAILED DESCRIPTION

An improved insurance offering is disclosed for limiting costs incurred by motor vehicle insurance providers as a result of abusive medical claims practices. As used herein, the term insurance provider (or insurer) includes commercial insurance providers (i.e., companies that offer insurance policies to consumers) as well as self-insured parties (e.g., not for profits, mutual or cooperatives, businesses, and governmental entities that provide insurance on behalf of employees). The term insured party refers to the beneficiary of an insurance policy (i.e., a party that may recover under the policy). The term policyholder refers to the party that obtains (i.e., pays for) an insurance policy. For commercial insurance, the disclosed insurance offering allows policyholders to participate in the decreased costs in the form of policy discounts. For self-insured parties that insure individuals such as employees by providing involuntary insurance, the insurance offering may be selected on behalf of the insured parties (i.e., without their direct election) and the decreased costs represent a direct cost savings to the self-insured party. A system for implementing the various insurance offerings is also disclosed.

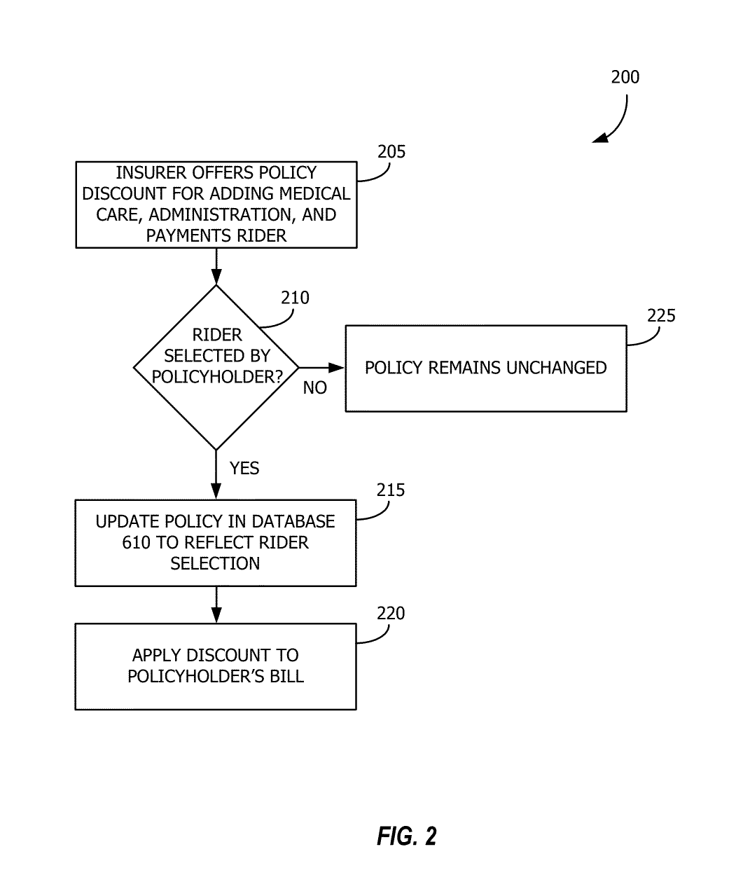

Referring to FIG. 2, process 200 provides an insurance offering that substantially reduces or eliminates the costs associated with abusive medical claims practices for “at will” or “any willing provider” provisions of motor vehicle insurance policies. Initially, an insurer offers a discount to policyholders (or potential new policyholders) in exchange for the policyholders' agreement to add a medical care, administration, and payments rider such as the MEDPLEX CARE ADVANTAGE rider to their motor vehicle insurance policies (block 205). MEDPLEX CARE ADVANTAGE is a service mark of Lucid Medical Management, LLC. While the medical care and payments clause is described herein as a rider, in another embodiment, the clause may be implemented as an option or endorsement or may be incorporated into the standard language of a motor vehicle insurance contract.

The medical care and payments rider may represent an agreement by a policyholder that insured parties will utilize healthcare providers that are members of an established network (EPN Exclusive Provider Network) for medical services that are provided as a result of a MVA and that will be paid under the policy. In one embodiment, the medical care and payments rider may enable an insured party to change healthcare providers a specified number of times (e.g., three times) during a medical care and recovery period. The medical care and payments rider may additionally allow an insured party that is unsatisfied with a network healthcare provider to obtain an independent review by a medical doctor to evaluate the insured party's care, testing, and treatment. In one embodiment, the network of providers may be established by a third party claims administrator (TPA) that markets the medical care and payments rider plan to insurers and self-insured parties such as businesses and governmental entities. The TPA may administer medical claims and coordinate medical care for insured parties that make medical claims on policies that include the medical care and payments rider. In another embodiment, the network of providers may be established by an insurer and the insurer may administer medical claims and coordinate medical care for insured parties that make medical claims on policies that include the medical care and payments rider. The network may be limited to providers that meet National Committee for Quality Assurance (NCQA) standards and are deemed trustworthy (e.g., providers that are board certified in their specialty, nationally accredited, current with Continuing Medical Education (CME), in good standing with their regulatory agencies/boards, have paid current state licenses and malpractice insurance, do not have any unreasonable malpractice claim history, etc.). Moreover, each provider in the network may contractually agree to reimbursement rates for common services. This is similar to existing arrangements used by health insurance providers and healthcare providers. In fact, in one embodiment, the TPA or insurer may negotiate with a health insurance provider to utilize the health insurance provider's established network and fee schedule. Such an arrangement would eliminate the need to independently establish a healthcare provider network.

In addition to the network provider specifications, the medical care and payments rider represents an agreement by a policyholder that any recovery for a medical claim under the motor vehicle insurance policy must be obtained in accordance with the policy provisions and not through a legal action against an insurer. Because policyholders that include the medical care and payments rider agree that insured parties seeking to recover under the policy will forego legal actions against the insurer, medical claims may be quickly resolved and healthcare providers may be reimbursed for services rendered in a much timelier manner than under existing motor vehicle insurance medical claims processes where no legal action occurs. Accordingly, healthcare providers may be enticed to join the provider network. Because the fees that are collectable by a healthcare provider are fixed at the agreed-upon rates and time to payment, the abusive medical claims practices described above may be substantially reduced or eliminated.

In exchange for including the medical care and payments rider in a motor vehicle insurance policy, a policyholder may be offered a policy discount. The expenses to the insurer that are incurred as a result of abusive medical claims practices will be most significantly reduced when a large number of policyholders have selected the medical care and payments rider. In order to entice as many policyholders as possible to select the medical care and payments rider, the insurer may pass a portion of these savings along to policyholders in the form of policy discounts. Such a discount may be given in the form of a reduced insurance premium, a no-cost reduction in a deductible on the policy, no point of care co-pays or other upfront cost, etc. For self-insured parties that provide involuntary insurance (e.g., to employees) the decreased costs may be maintained by the self-insured party as a direct and ongoing savings.

The medical care and payments rider may be offered by the insurer in a variety of ways. For example, the medical care and payments rider may be presented as a selectable option when configuring a new insurance policy. Likewise, the medical care and payments rider may be presented as a selectable option at the time a policy is to be renewed. The medical care and payments rider may also be offered to existing policyholders during the term of a policy by including a copy of the rider in a mailing with the policyholder's premium statement and allowing the policyholder to mail a signed copy of the rider back to the insurer. For example, the premium statement may specify a first premium that applies if the rider is not returned and a second discounted premium (e.g., that applies to current and future payments) if the rider is returned. The insurer may also allow existing policyholders to select and electronically sign the medical care and payments rider via a web interface.

In one embodiment, a policyholder may select the medical care and payments rider after a coverage-triggering event (e.g., after an insured party initiates a claim following a MVA). This ability to add the medical care and payments rider after a coverage-triggering event represents a significant distinction from typical insurance processes. Insurance operates by receiving a premium from a customer in order to obtain coverage over a certain time period. If that premium has been paid to an insurance provider, then, after a coverage-triggering event has occurred, a customer may request that the insurance provider cover expenses that resulted from the event. Due to the nature of this insurance business model, expenses that were incurred as a result of an event will not be covered if the event occurred prior to the effective date of an insurance policy. However, the nature of the disclosed medical care and payments rider enables selection by a policyholder after a coverage-triggering event. In fact, policyholders for policies on which an insured party has initiated a claim process after a MVA and that do not yet include the medical care and payments rider may represent the most beneficial class of policyholders in terms of reducing costs associated with abusive medical and legal claims practices. For this class of policyholders, reduced costs based on the elimination of abusive medical and legal claims practices may be realized by the insurer immediately. Consequently, in one embodiment, this class of policyholders may be offered one or more additional incentives for selecting the medical care and payments rider. For example, the insurer, in addition to offering decreased future premiums, may also offer retroactive premium reductions, reduced deductibles for property damage incurred as a result of the MVA, and/or an agreement not to cancel the policy, etc.

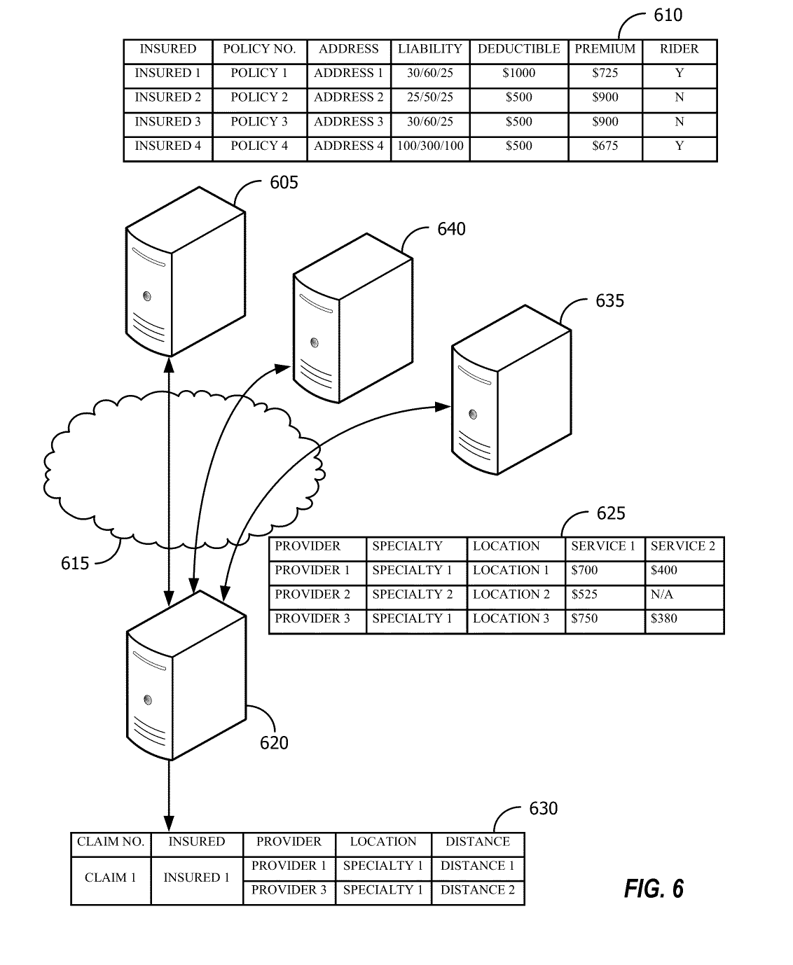

If a policyholder selects the medical care and payments rider (the “Yes” prong of block 210), the policy may be updated within the insurer's database (e.g., database 610 of FIG. 6) to reflect the selection of the rider (block 215). The policy discount that was offered will then be applied, reducing the policyholder's bill (block 220). If the rider is not selected by a policyholder, the policy will remain unchanged (block 225). Therefore, policyholders that do not select the medical care and payments rider will see no change to their insurance coverage.

Although process 200 has been described in terms of a bargained-for exchange between an insurer and a policyholder, it should be noted that the medical care and payments rider is equally (if not more) valuable in terms of a self-insured party that provides involuntary insurance (e.g., to employees). For example, an employer may be a self-insured party that provides motor vehicle insurance for its employees for acts within the scope of their employment or coverage for acts that are outside the scope and purpose of their employment (e.g., coverage for a MVA while driving a company or government vehicle during off clock time such as during lunch). A TPA may offer to administer medical claims and coordinate medical care for insured parties (e.g., employees) under the terms of the employer's motor vehicle insurance provisions. In such a scenario, the employer may accept the medical care and payments rider on behalf of its employees such that any employee that makes a medical claim under the motor vehicle insurance policy provided by the employer must comply with the terms of the medical care and payments rider. In this involuntary insurance market, there is no bargained-for exchange between an insurer and a policyholder but rather an acceptance of the terms of the medical care and payments rider on behalf of the insured parties by the self-insured party (i.e., the provider of the insurance). The self-insured party may therefore enjoy the savings from decreased abusive medical claims practices as a direct cost savings.

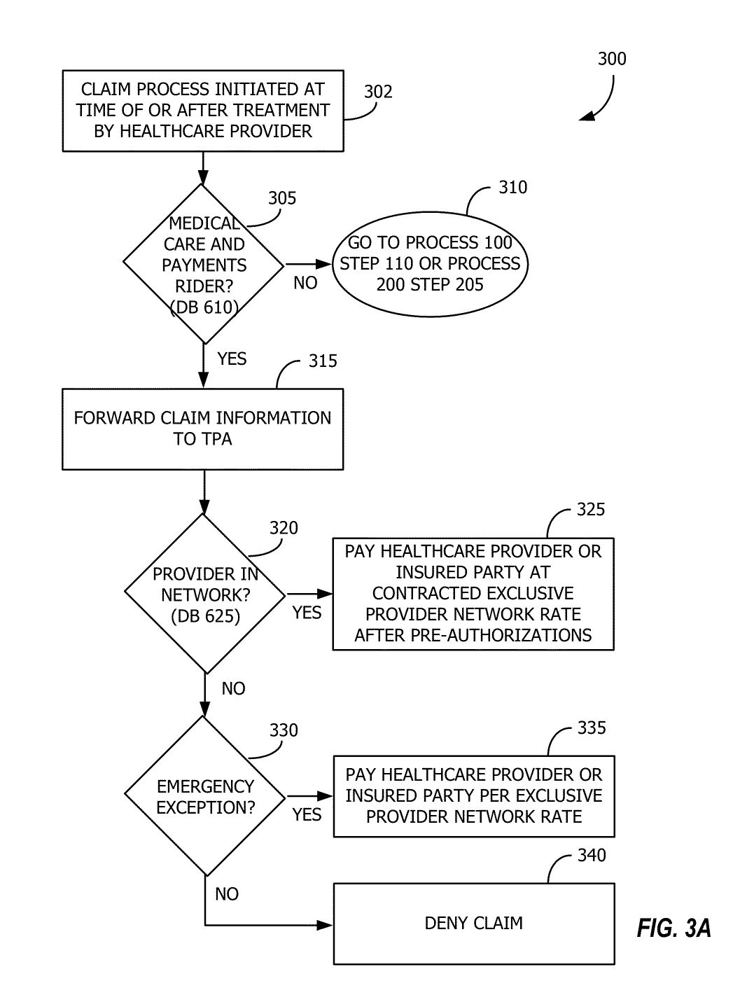

Referring to FIG. 3A, a process 300 for the administration of medical claims by a TPA in accordance with the above-described medical care and payments rider begins when an insured party initiates the claim process at the time of or after receiving care, tests, or being otherwise treated by a healthcare provider (block 302). When an insured party initiates the claim process (e.g., after a MVA), it may be determined whether the insured party's policy (i.e., the policy under which the insured party has initiated the claim) includes the medical care and payments rider (block 305). As noted above, the medical care and payments rider could be selected at essentially any time, even after the claims process has been initiated. The determination of whether the policy includes the medical care and payments rider may be performed by querying the records for the insured party's policy in the insurer's database (e.g., database 610). It should be noted that the party and policy provision that is responsible for payment of a particular claim (i.e., as indicated in process 100) is unchanged by the medical rider. The medical care and payments rider applies only to payments made by the insured party's policy. That is, an insured party is only required to use network providers in accordance with the medical care and payments rider when the insured party's own policy is covering the expenses (i.e., as in blocks 125 and 130 of process 100). Accordingly, process 300 is directed only to the administration of medical claims and coordination of medical care from approved network providers when the medical claims are covered under the insured party's policy.

If the insured party's policy does not include the medical care and payments rider (the “No” prong of block 305), the claims process may continue in accordance with existing claim process 100 at block 110 or the rider offering process 200 at block 205 (block 310). However, if the insured party's policy does include the medical care and payments rider (the “Yes” prong of block 305), claim information may be forwarded to the TPA for administration of the medical portion of the claim (block 315). The forwarded information may include policy information (e.g., information extracted from the insurer database), MVA information (e.g., the injured parties, the types of injuries sustained, etc.), and claim specific information (e.g., healthcare services rendered, the provider that rendered services, the cost of the rendered services, etc.). In one embodiment, all claim specific information may be submitted (e.g., by the insured party or a healthcare provider that renders services for the insured party) to the insurer and forwarded by the insurer to the TPA. In another embodiment, claim specific information may be submitted directly to the TPA. In such an embodiment, the policy and MVA information may initially be forwarded from the insurer to the TPA and subsequent medical claim information may be submitted directly to the TPA.

For each medical claim submitted by or on behalf of the insured party, it may be determined whether the provider that rendered medical services with respect to that claim is part of the pre-established provider network (block 320). This determination may be made by querying a database listing of the network providers (e.g., database 625 of FIG. 6) to locate a match for an identifier of the healthcare provider that rendered the services. If the healthcare provider is part of the network (the “Yes” prong of block 320), the healthcare provider or the insured party may be paid the contracted rate for services performed with respect to the claim (block 325). In one embodiment, payment of the healthcare provider at the contracted rate may require that the healthcare provider receive pre-authorization from the TPA for services to be performed. It will be understood that the contracted rate may be different than the billed amount, but, because the healthcare provider has agreed to certain contracted rates, the healthcare provider will only be paid the contracted rate. In one embodiment, the healthcare provider may be paid directly by the TPA. In another embodiment, the agreed amount may be provided by the TPA to the insured party for payment of the medical expenses. In yet another embodiment, the insurer pays the claim (either to the healthcare provider or the insured party) after the TPA approves the legitimate authorized medical claim. The contracted rate that is due to a particular network provider may be retrieved from the database listing of network providers (e.g., database 625). Different network healthcare providers may agree to different rates for the same service (e.g., based on the provider's location, the provider's specialty, etc.). Consequently, the amount due to a particular provider for services rendered to the insured party may be specific to the particular provider.

If it is determined that the healthcare provider that rendered services with respect to a submitted claim is not a network provider (the “No” prong of block 320), it may be determined if the claim is subject to an emergency exception (block 330). In one embodiment, the medical care and payments rider may include an exception that covers medical expenses for emergency medical services provided by non-network providers. That is, an insured party may not be required to use a network provider for emergency medical services that are performed as a result of a MVA. If the emergency exception applies to the submitted claim (the “Yes” prong of block 330), the healthcare provider or the insured party may be paid at a rate set in accordance with the provider network (block 335). Payments may be made to the healthcare provider or insured party by the TPA or insurer as described above with respect to block 325. In one embodiment, the emergency exception may specify that a healthcare provider that renders services may be reimbursed at a particular rate determined based on the contracted rates for the same services performed by network providers. In such an embodiment, the healthcare provider that rendered the emergency medical services may be paid at the specified rate rather than the billed amount (in which case the insured party may be responsible for the difference). In another embodiment, the medical care and payments rider may specify that a non-network emergency services provider will be reimbursed at the amount billed by the provider. In such an embodiment, the rider may include a provision requiring the insured party to visit a network provider within a specified time period after services are obtained from a non-network emergency care provider in order to verify the need for and costs of the services.

If the claim is not subject to the emergency exception (the “No” prong of block 330), the claim may be denied (block 340). Because the insured party is bound by the medical care and payments rider, medical expenses that do not comply with the medical care and payments rider will not be paid. The insured party may be sent a notice indicating that the claim has been denied and the reasons for the denial of the claim. Steps 320 through 340 of process 300 may be repeated for each medical claim received by the TPA (e.g., either directly or forwarded from the insurer) with respect to the particular event giving rise to the motor vehicle insurance policy claim (e.g., a car or truck MVA).

As noted above, in addition to limiting insured parties to a network of approved, accredited healthcare providers, the medical care and payments rider may specify that recovery under the policy may only be obtained in accordance with the policy and not by bringing a legal action against the insurer. The medical care and payments rider may also set a maximum amount that can be collected by a legal professional that is engaged by an insured party to enforce the rights of the insured party after an MVA (e.g., a limited amount for the review of medical claims processing). Fee-sharing arrangements between legal and medical professionals are eliminated because the TPA separately pays or approves payment for the legal services (which eliminates the direction of medical care by a legal practitioner) and contracted medical services and because fees for medical services are paid based on the agreed fee schedule. Under this arrangement, barratry becomes less of a concern, and the costs borne by the insurance system and self-insured parties are decreased. Moreover, insured parties that do not subscribe to the medical care and payments rider will not experience any change in insurance coverage.

As noted above, an insured party is only required to utilize network healthcare providers for expenses to be paid under the insured party's own policy. However, because the at-fault party and the at-fault party's ability to pay may not be known at the time a medical service is needed, it may typically be beneficial for an insured party to use a network provider even where another party may eventually be responsible for payment.

For example, assume that driver Alice and her dependent child passenger Bob are in a vehicle that is involved in a MVA with a vehicle driven by Charlie. If all of the parties are injured in the MVA and Alice is a policyholder that has selected the medical care and payments rider, Alice and Bob (each an insured party under the policy) may initially be referred to in-network healthcare providers administered by the TPA. If Alice is determined to be at fault, the insurance policy will only cover medical expenses for services provided to Alice and Bob by network healthcare providers administered by the TPA. The policy will also cover Charlie's medical expenses (subject to the liability provisions of Alice's policy), but Charlie will not be limited to the TPA and network providers because he has not contracted to do so with Alice's insurer. If Charlie is determined to be at fault, Alice and Bob may not be limited to the TPA and network healthcare providers. However, it may be beneficial for Alice and Bob to use the TPA and network healthcare providers even if Charlie is at fault because the fault determination may not occur until a significant amount of time after the MVA or may never occur at all. Moreover, even if Charlie is insured, if Alice and Bob's expenses exceed the liability limits of Charlie's insurance policy, the remaining expenses may be covered under the PIP and/or underinsured party portion of Alice's policy, which may be subject to the medical care and payments rider and require the use of the TPA and its network providers.

Referring to FIG. 3B, a process 350 for the administration of medical claims by a TPA in accordance with the above-described medical care and payments rider begins when an insured party initiates the claim process before being treated by a healthcare provider (block 304). As described above with respect to process 300, it may be determined whether the insured party's policy includes the medical care and payments rider (block 305). If the insured party's policy does not include the medical care and payments rider (the “No” prong of block 305), the claims process may continue in accordance with existing claim process 100 at block 110 or the rider offering process 200 at block 205 (block 310). However, if the insured party's policy does include the medical care and payments rider (the “Yes” prong of block 305), the insurer may forward information regarding the insured party's policy and the MVA to the TPA (block 355). This information may be retrieved from the insurer's database as well as from information provided by the insured party as part of the claim initiation process. Because process 350 is directed to the initiation of the claim process prior to obtaining care, tests, or treatment from a healthcare provider, the forwarded information will not include claim specific medical information. The claim specific information may be later provided to the insurer and forwarded to the TPA or provided directly to the TPA after the insured party obtains care, tests, or treatment from a healthcare provider. The claim may then be processed in accordance with process 300 described above. The information provided by the insurer to the TPA may include a location for the insured party (e.g., a billing address from the insurer's database) as well as information regarding the types of injuries that were sustained as a result of the MVA. This information, as well as any other information provided by the insurer, may be utilized to query a database of network providers (e.g., database 625) (block 360). For example, a query may be structured to identify healthcare providers that participate in the network and that have a particular specialty (e.g., based on the types of injuries) and are located within a certain distance from the insured party's address, work, school, or site of the MVA. In one embodiment, the query may be customizable by the insured party. For example, the TPA may provide a web interface that enables a user to locate all network providers within a specified distance of a location indicated by the insured party. Based on the information obtained from the database of network providers, a list of relevant healthcare providers (e.g., database 630 of FIG. 6) may be presented to the insured party (block 365).

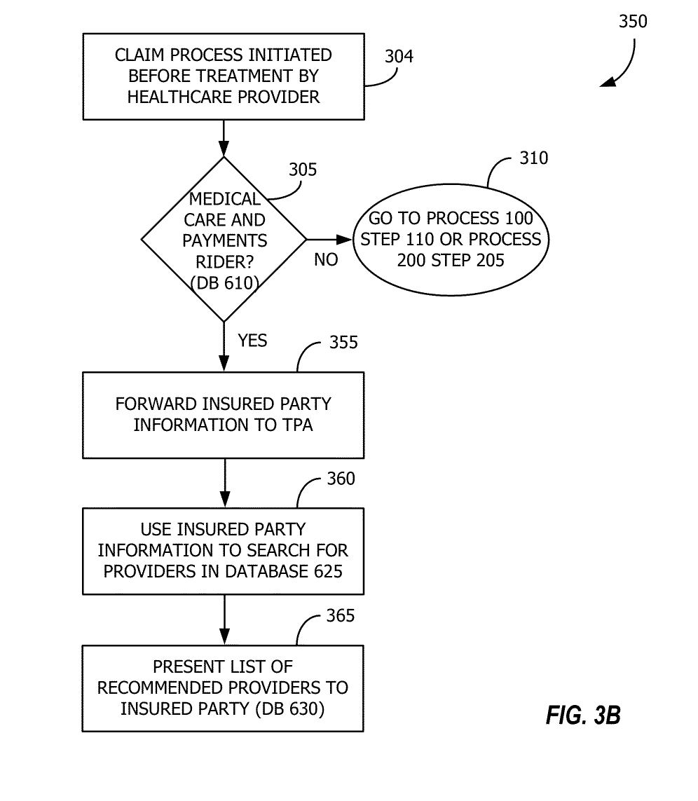

In addition to processing claims in accordance with the medical care and payments rider, the TPA may also manage medical care associated with medical claims. For example, the TPA may aggregate information related to a MVA from multiple sources to coordinate medical care. FIG. 4 illustrates an example timeline of events associated with driver 410 and passenger 415 that are insured parties involved in a MVA 405. In the illustrated example, driver 410 is treated soon after MVA 405 by provider 425. For example, provider 425 may be an emergency physician that provides initial medical services 435 (e.g., medical tests) to determine the type and extent of driver 410's injuries. Information regarding services 435 (e.g., test results, tests performed, etc.) may be provided to the TPA (e.g., in the form of a medical bill submitted by provider 425 to the TPA, in response to an inquiry by the TPA with respect to a pre-authorization request for subsequent services, etc.). Provider 425 may thereafter perform services 440. Services 440 may include follow-up tests or procedures. Information regarding services 440 may also be provided to the TPA. Based on the results of services 440, provider 425 may recommend that driver 410 consult a specialist. Provider 425's recommendation that driver 410 consult a specialist may be communicated to the TPA. As noted above, using information associated with the TPA's network of healthcare providers, one or more provider recommendations may be provided to driver 410. Based on the one or more recommendations provided by the TPA, driver 410 may select provider 420, a specialist of the type recommended by provider 425 and within the provider network. Provider 420 may perform services 445 and 450. Similarly, after waiting for a period of time after MVA 405, passenger 415 may obtain services 455 and later services 460 from provider 430.

Each event in the timeline represents an opportunity for the TPA to collect information to guide future medical care decisions. For example, information regarding the MVA (e.g., the type of collision, the amount of property damage, the location of impact, etc.) provides valuable information regarding the likely extent and types of injuries sustained. Each subsequent test, treatment, or procedure performed by a healthcare provider provides additional information regarding the appropriate course of future medical care. By aggregating this information into a software module that incorporates accepted medical and insurance guidelines, the TPA may be able to provide medical care recommendations and make informed decisions regarding the authorization for additional medical services. The medical guidelines may represent accepted medical standards for the provision of medical care given a certain medical care history. Similarly, insurance guidelines may represent accepted insurance standards for managing the costs of medical care given a certain medical care history. By evaluating accident and medical care information in the context of accepted medical and insurance guidelines, the TPA may more efficiently manage ongoing medical care. For example, a healthcare provider may request authorization to perform a test without knowing that the same type of test was recently performed by another healthcare provider. Because the TPA is aware of the previous test, the request may be denied and the results of the earlier test may be provided to the healthcare provider. Similarly, the TPA may authorize a more detailed test than a test for which authorization is requested when the medical and insurance guidelines suggest that the more detailed test is the appropriate course based on the current medical care history. Because the TPA maintains a “bird's eye view” of the medical care process, medical care can be provided more efficiently and more quickly. Consequently, medical claims can be resolved and healthcare providers can be reimbursed more quickly than under existing motor vehicle insurance provisions, especially for cases where an injured party employs an attorney and potential or actual litigation exists.

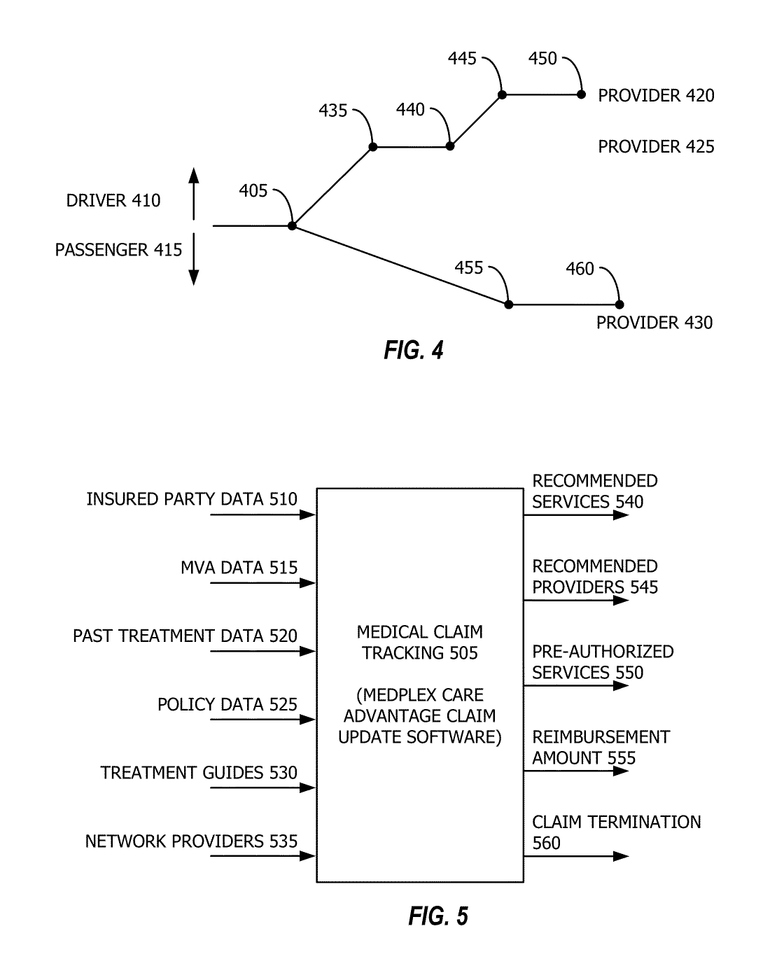

Referring to FIG. 5, medical claim tracking software module 505 aggregates information related to a MVA to identify an immediate path to a best outcome that is re-evaluated at each healthcare encounter. The aggregated information includes data about an insured party that is seeking and/or has obtained medical care as a result of a MVA 510, data about the MVA 515, past treatment data for an insured party 520, insurance policy data 525, medical and insurance guides 530, and network provider information 535 (e.g., obtained from database 625). Insured party data 510 may include identifying information about an insured party (e.g., name, age, gender, etc.) as well as past medical history information for the insured party. MVA data 515 may include information obtained from a police report and/or information obtained from an insurer that describes the type and seriousness of the MVA. Past treatment data 520 may include information describing medical care that has been provided as a result of the MVA. Treatment guides 530 may include medical and insurance guidelines that specify a typical course of action given a particular set of facts. Treatment guides 530 may include the MEDPLEX CARE ADVANTAGE ClaimUpDate guide, Official Disability Guidelines (ODG), Medical Disability Advisor (MDA), MD Guidelines, Colossus, MedTree QDS, InterQual, Milliman Care Guidelines (MCG), and other related medical and insurance guides. Network provider data 535 may include a list of healthcare providers that are in the healthcare network along with information associated with the healthcare providers. Using the aggregated information, the medical claim tracking software module 505 may generate recommended medical services 540, recommended healthcare providers 545, pre-authorizations for medical services requested by healthcare providers 550, reimbursement amounts 555, and claim termination decisions 560.

Referring to FIG. 6, a system for implementing one or more portions of the above-described processes for the administration of medical claims and coordination of medical care include network computing devices (e.g., server computers) that maintain information regarding motor vehicle insurance policy provisions. Server 605 may be maintained by an insurer that offers its policyholders the ability to select the medical care and payments rider in exchange for certain discounts such as reduced insurance premiums. Although each of servers 605, 620, 635, and 640 is illustrated as a single device, in an actual implementation, multiple computing devices may be utilized to perform the described functions.

The provisions of a particular motor vehicle insurance policy may be customizable based on the needs of the individual policyholder and the requirements of the state in which the policyholder resides or where the MVA occurred. For example, a policyholder may select liability limits (i.e., the caps on the amount the policy will pay to another party for medical expenses and property damages when an insured party is at fault for the damages) that meet or exceed the limits required by the state in which the policyholder resides or where the MVA occurred. These limits are typically expressed as X/Y/Z, where X is the dollar amount limit (in thousands) per person for bodily injury, Y is the dollar amount limit (in thousands) per MVA for bodily injury, and Z is the dollar amount limit (in thousands) per MVA for property damage. In addition, the policyholder may select additional coverage to protect themselves against property damage to their own vehicles (e.g., comprehensive and collision coverage), medical expenses that occur as a result of a MVA for which no other party is at fault (e.g., the PIP or MedPay coverage described above), or medical expenses and property damage caused by another party that is incapable of paying for the damages (e.g., uninsured and underinsured party). These additional selections may be further refined by customizing the deductible amounts (i.e., the amount that is paid by an insured party/policyholder before the insurer will cover damages) associated with these provisions. The selected provisions and the characteristics of the individuals covered under the policy (e.g., age, gender, driving record, claims history, credit score, vehicle cost, age, condition, etc.) will result in a policy premium. As noted above, a discount may be applied to this premium if a policyholder selects the medical care and payments rider in the insurance policy. Similarly, a self-insured party may benefit from direct savings by selecting the medical care and payments rider. All of the information for the specific provisions for each of an insurer's policyholders as well as identifying information for the policyholders may be included in insurer's database 610 that is stored on server 605. Database 610 may include fields for the policyholder's name, insured parties, the policy number, the policyholder's billing address, the liability limits on the policy, the deductible applicable to comprehensive and/or collision claims, the premium (e.g., semi-annual premium), and whether or not the policyholder has selected the medical care and payments rider. The illustrated fields are provided as an example only. An insurer's database may typically include numerous additional fields for policy and policyholder information.

Server 605 may be connected to network 615. The network connection may take any form including, but not limited to, a local area network (LAN), a wide area network (WAN) such as the Internet or a combination of local and wide area networks. Moreover, the network may use any desired technology, or combination of technologies (wired, wireless or a combination thereof) and protocol (e.g., transmission control protocol, TCP). Server 605 may communicate with server 620 over network 615. Server 620 may execute medical claim tracking software module 505 for administration of medical claims and coordination of medical care. Server 620 may be maintained by a TPA that manages medical claims for insured parties having policies that include the medical care and payments rider as described above. In one embodiment, server 620 may store database 625 that includes information for healthcare providers in the provider network that is applicable to medical claims for insured parties having policies that include the medical care and payments rider. By way of example, database 625 may include the names of healthcare providers in the network as well as their specialties, credentials, locations, and the rates the providers have agreed to for common services. The illustrated fields are provided as an example only. A database of network providers may include numerous additional fields for network provider information. In another embodiment, database 625 may be maintained on server 635 that is maintained by another party (e.g., a party other than the insurer and the TPA). For example, as noted above, the TPA may utilize a health insurance provider's network and fee schedule. Similarly, the TPA may utilize any or multiple of a state's workers' compensation provider networks and fee schedules or combinations thereof. In either case, database 625 may be constantly changing (e.g., as providers enter and leave the network and/or agree to different reimbursement rates) and may be maintained on a server (i.e., server 635) that is managed by the party that manages the provider network. In such an embodiment, information from database 625 may be retrieved by server 620 via a network query. Server 620 may additionally be in communication with one or more healthcare provider servers 640. Each healthcare provider server 640 may be maintained by an individual healthcare provider or a group of healthcare providers and may be utilized to communicate with server 625. Communication between healthcare provider servers 640 and server 625 may allow for the submission of (and reply to) requests for reimbursement for medical services rendered by a healthcare provider, the submission of (and reply to) requests for pre-authorization for medical services, etc. Although server 620 is illustrated as being connected to servers 635 and 640 via the same network (i.e., network 615) as servers 605 and 620, they may also be connected via a different or multiple networks.

As described above with respect to process 300, when an insured party initiates a claim through the insurer, it may be determined if the claim will involve any medical expenses (i.e., if any injuries were sustained as a result of the MVA) and, if so, if the insured party's policy includes the medical care and payments rider (e.g., by querying database 610). If the insured party's policy does include the medical care and payments rider, relevant information regarding the claim as well as information from database 610 (e.g., insured party's name and address, medical coverage provisions, etc.) may be forwarded from server 605 to server 620 via network 615. Claim information that is received by the TPA (either directly or forwarded from the insurer) may be evaluated for compliance with the medical care and payments rider, TPA, or insurer contracts with healthcare providers to determine whether or not the claim is allowable (e.g., whether pre-authorization has been received if required, whether an approved network healthcare provider has been utilized, etc.). The claim evaluation process may be performed at least in part by matching claim information (e.g., an identifier for a provider that performed services with respect to the claim) with information from database 625.

Database 625 may additionally be utilized to generate provider recommendations as described above with respect to process 350. In the illustrated embodiment, policyholder “Insured 1” has initiated the claim process through an insurer (e.g., by web interface, email, calling the insurer, using a mobile application provided by the insurer, etc.). Because the applicable policy includes the medical care and payments rider, information regarding the policy and the MVA is forwarded from server 605 to server 620 such that the TPA can administer and coordinate subsequent medical care and claims. Using this information, server 620 queries database 625 to identify medical providers in the provider network that specialize in an area of medicine that will be required as a result of injuries sustained in the MVA and who are located in close proximity to the insured party's location. This information is then compiled into database 630 that is maintained on server 620, which includes a claim identifier, the name of the insured party and any guardians, a list of providers in the network that satisfy the query (e.g., having the identified specialty and practicing within a particular region), the provider's specialties, and the distance between the provider's location (as indicated in database 625) and the insured party's residence, work, or school for voluntary insurance and employer's address or employee's residence for involuntary insurance. The information from database 630 may be accessible to an insured party through a web interface provided by the TPA. Using this system, medical claims administered by the TPA may be integrated seamlessly with the insurer's typical claim process.

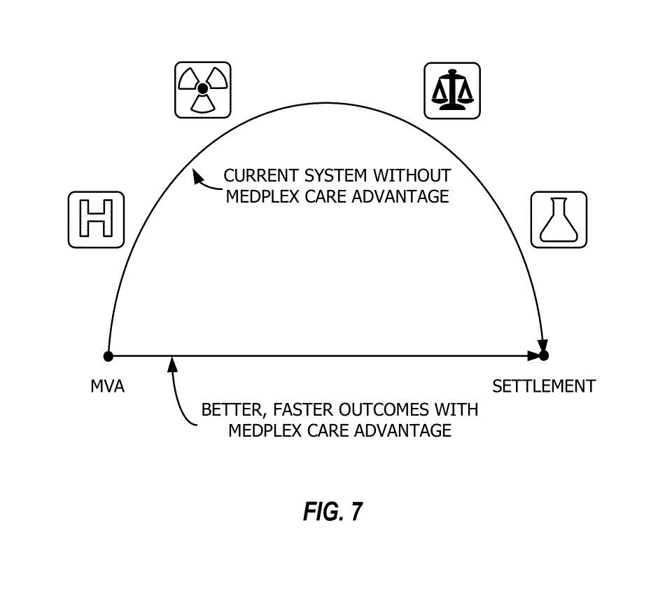

FIG. 7 shows a block diagram that conceptually illustrates the indirect path from a MVA to the settlement of medical claims related to the MVA based on the various treatments tests, legal claims, and other hurdles that are presented in the current motor vehicle insurance system. By contrast, the disclosed MEDPLEX CARE ADVANTAGE system provides a more direct path between the MVA and the settlement of medical claims related to the MVA through the usage of the medical care and payments rider and the administration of medical care as described above.

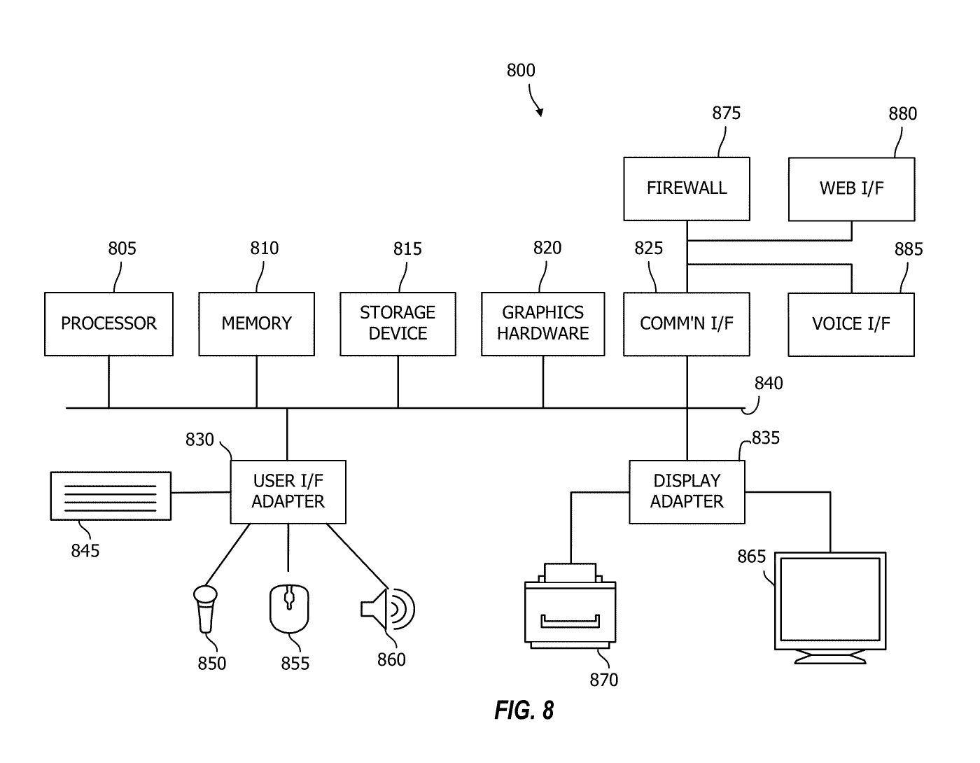

FIG. 8 shows a representative hardware environment that may be associated with the servers 605, 620, 635, and 640 of FIG. 6, in accordance with one embodiment. Representative device 800 includes processor 805, memory 810, storage 815, graphics hardware 820, communication interface 825, user interface adapter 830 and display adapter 835—all of which may be coupled via system bus or backplane 840. Memory 810 may include one or more different types of media (typically solid-state) used by processor 805 and graphics hardware 820. For example, memory 810 may include memory cache, read-only memory (ROM), and/or random access memory (RAM). Storage 815 may store media, computer program instructions or software, preference information, device profile information, and any other suitable data. Storage 815 may include one or more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), Electrically Erasable Programmable Read-Only Memory (EEPROM), and USB or thumb drive. Memory 810 and storage 815 may be used to tangibly retain computer program instructions or code organized into one or more modules and written in any desired computer programming language. When executed by processor 805 and/or graphics processor 820 such computer program code may implement one or more of the processes described herein. Communication interface 825 may be used to connect system 800 to a network (e.g., network 615). Communications directed to system 800 may be passed through protective firewall 875. Such communications may be interpreted via web interface 880 or voice communications interface 885. Illustrative networks include, but are not limited to: a local network such as a USB network; a business' local area network; or a wide area network such as the Internet. User interface adapter 830 may be used to connect keyboard 845, microphone 850, pointer device 855, speaker 860 and other user interface devices such as a touch-pad and/or a touch screen (not shown). Display adapter 835 may be used to connect display 865 and printer 870.

Processor 805 may include any programmable control device. Processor 805 may also be implemented as a custom designed circuit that may be embodied in hardware devices such as application specific integrated circuits (ASICs) and field programmable gate arrays (FPGAs). Any of the devices described above (e.g., servers 605, 620, and 635) may include some or all of the components of system 800. Moreover, while the disclosed processes have been described in terms of server computer systems, these processes may also be applicable to other types of devices having some or all of the components of system 800. System 800 may have resident thereon any desired operating system.

The disclosed system and techniques provide an improved motor vehicle insurance offering for substantially reducing or eliminating illegitimate costs incurred by insurance providers and self-insured employers as a result of fraudulent medical and or legal claims made under motor vehicle insurance policies. Using the disclosed system and techniques, the insurance offering can be seamlessly integrated into existing insurance processes, risk management systems and self-insured government and employer software systems.

1. A method, comprising:
receiving information related to a medical claim by an insured party identified in an insurance policy, the information including an identifier of a service provider that provided healthcare services to the insured party;
determining whether the policy includes a medical care and payments provision that requires the insured party to utilize one or more of a plurality of healthcare providers in a specified network of healthcare providers for medical claims under the policy; and
determining whether the service provider is one of the plurality of healthcare providers when it is determined that the policy includes the medical care and payments provision.

2. The method of claim 1, wherein the insurance policy is a motor vehicle policy.

3. A system, comprising:
a processor; and
a memory operatively coupled to the processor and storing program code to cause the processor to:
receive information related to a medical claim by an insured party identified in an insurance policy, the information including an identifier of a service provider that provided healthcare services to the insured party;
query a database to determine whether the policy includes a medical care and payments provision that requires the insured party to utilize one or more of a plurality of healthcare providers in a specified network of healthcare providers for medical claims under the policy; and
query a database to determine whether the service provider is one of the plurality of healthcare providers when it is determined that the policy includes the medical care and payments provision.

4. The system of claim 3, wherein the insurance policy is a motor vehicle policy.

5. A method, comprising:
receiving information regarding an initiation of a claim under an insurance policy;
determining whether the policy includes a medical care and payments provision that requires an insured party to utilize one or more of a plurality of healthcare providers in a specified network of healthcare providers for medical claims under the policy; and
forwarding policy information to a third party administrator for administration of the claim when it is determined that the policy includes the medical care and payments provision.

6. The method of claim 5, wherein the insurance policy is a motor vehicle policy.

7. A system, comprising:
a processor; and
a memory operatively coupled to the processor and storing program code to cause the processor to:
receive information regarding an initiation of a claim under an insurance policy;
query a database to determine whether the policy includes a medical care and payments provision that requires an insured party to utilize one or more of a plurality of healthcare providers in a specified network of healthcare providers for medical claims under the policy; and
forward information from the database to a third party administrator when it is determined that the policy includes the medical care and payments provision.

8. The system of claim 7, wherein the insurance policy is a motor vehicle policy.

9. A method, comprising:
receiving information regarding an initiation of a claim by an insured party identified in an insurance policy;
determining whether the policy includes a medical care and payments provision that requires the insured party to utilize one or more of a plurality of healthcare providers in a specified network of healthcare providers for medical claims under the policy;
identifying a set of healthcare providers from the plurality of healthcare providers as relevant to the claim based, at least in part, on information associated with the policy when it is determined that the policy includes the medical care and payments provision; and
providing a list of the set of healthcare providers to the insured party.

10. The method of claim 9, wherein the insurance policy is a motor vehicle policy.

11. A system, comprising:
a processor; and
a memory operatively coupled to the processor and storing program code to cause the processor to:
receive information regarding an initiation of a claim by an insured party identified in an insurance policy;
query a first database to determine whether the policy includes a medical care and payments provision that requires the insured party to utilize one or more of a plurality of healthcare providers in a specified network of healthcare providers for medical claims under the policy;
query a second database to identify a set of healthcare providers from the plurality of healthcare providers as relevant to the claim based, at least in part, on information associated with the policy when it is determined that the policy includes the medical care and payments provision; and
provide a list of the set of healthcare providers to the insured party.

12. The system of claim 11, wherein the insurance policy is a motor vehicle policy.
